(19) United States
(12) Patent Application Publication
(10) Pub. No.: US 2008/0205471 A1
(43) Pub. Date: Aug. 28, 2008

(54) Adjusting the Composition of a Process Gas in a Laser Processing System

(75) Inventors: Thomas Harrer, Waldenbuch (DE); Michael Wessner, Gerlingen (DE)

Correspondence Address: FISH & RICHARDSON PC, P.O. BOX 1022, MINNEAPOLIS, MN, 55440-1022, US

(73) Assignee: TRUMPF WERKZEUGMASCHINEN GMBH + CO. KG, Ditzingen (DE)

(21) Appl. No.: 11/994,465

(22) PCT Filed: Jul. 2, 2005
(86) PCT No.: PCT/EP2005/007167

§ 371 Date: Mar. 13, 2008

(51) Int. Cl. H01S 3/104; H01S 3/22

(52) U.S. Cl. 372/58; 372/38.02; 372/59

(57) ABSTRACT

A laser processing system includes a laser processing means, a gas mixing unit, and a controller. The controller controls and adjusts the composition of the process gas for laser processing. The controller includes a data storage for technology tables by means of which the composition of the process gas is controlled and adjusted.

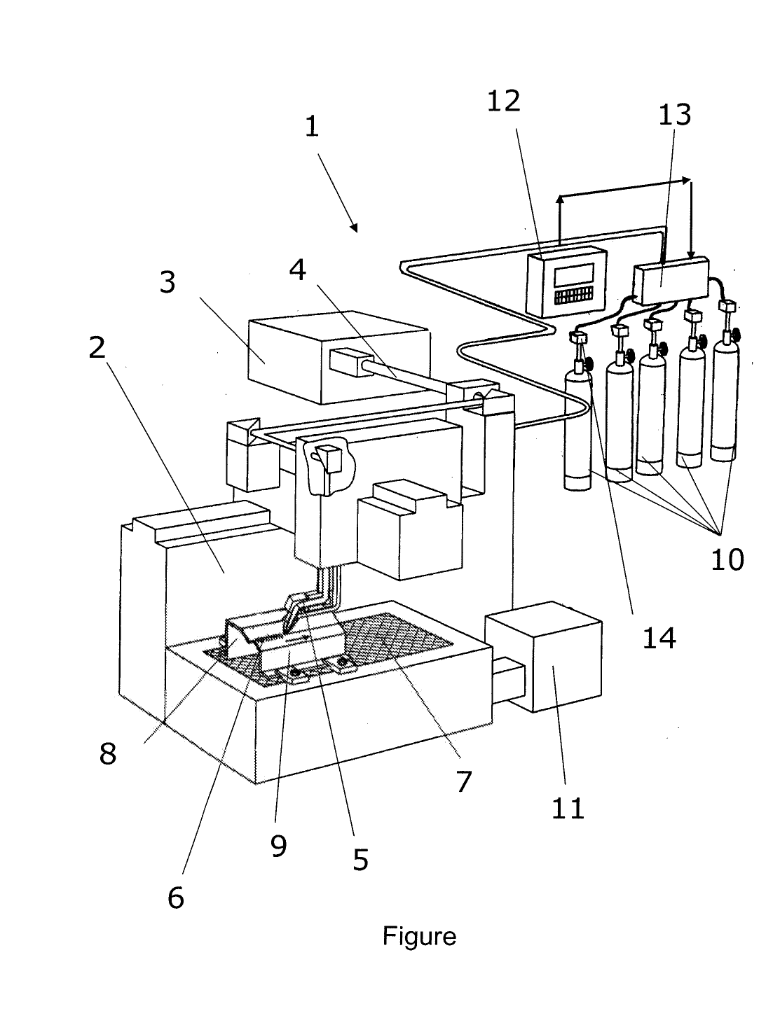

### TECHNICAL FIELD

The invention relates to a laser processing system. More particularly, the invention relates to a laser processing system with a laser processing device, a gas supply unit, a gas mixing unit and a controller for controlling and adjusting the composition of a process gas for laser processing.

### BACKGROUND

The use of a gas mixing unit in a laser processing system for laser welding is disclosed e.g. in EP 527229 A1.

Based on the welding task, the type and amount of the process gas is generally selected, and manually adjusted. The experience of the user is thereby a decisive factor.

What is needed, therefore, is an automated selection and adjustment of the process gas during laser welding.

### SUMMARY

In one aspect of the invention, a laser processing system includes a laser processing device, a gas supply unit, a gas mixing unit, and a controller for controlling and adjusting a composition of a process gas for laser processing, wherein the controller has a data storage for technology tables by means of which the composition of the process gas is controlled and adjusted. The experience of the user is complemented by systematic experimental results, which can be transmitted to the laser processing system.

In some embodiments, the control and adjustment of the composition of the process gas is performed automatically to prevent processing errors. Other embodiments are, however, also feasible, such as performance of a method using NC programming or interactive query and entry of data by the user.

### DESCRIPTION OF THE DRAWING

The drawing schematically shows an exemplary embodiment of the invention, which is described in more detail below with reference to the FIGURE of the drawing. The FIGURE shows a laser processing system for laser welding. The invention can also be similarly used for laser cutting.

### DETAILED DESCRIPTION

The FIGURE shows a setup of a laser processing system 1 for laser welding. A machine frame 2 bears the motion control unit of the machine and the beam guiding system with deflecting mirrors for a laser beam 4 generated in the laser 3.

A laser welding head 5 with a deflecting mirror and a focusing mirror can be moved in three directions via two axes of rotation in order to provide optimum processing of a welding seam 6 for joining two components 8 and 9 which are disposed on a support 7. The components 8 and 9 are fixed by means of a clamping device. Process gases 10, such as working gases or protective gases (helium, argon, carbon dioxide, oxygen, nitrogen) can be supplied to the laser welding head 5 for laser welding, and be drawn out via a suction device 11.

A controller 12 is used in connection with a gas mixing unit 13 and control valves 14 for adjusting the composition of the process gas to the respective processing task during laser welding. The controller 12 includes a display, a CPU, a data storage, an input and a data exchange device with the laser processing system 1. The values of different parameters, which are important for laser welding, may be contained in a NC text or be called within the NC text. In a preferred method, the data is managed in so-called technology tables in the form of technology data. Only these tables are called in the NC text itself. Each technology table has assigned a number. All tables are centrally managed and maintained and are stored in the controller 12. The tables are created for each material type and thickness. The tables contain optimized data that depend on the laser, the laser power, the feed rate, the focus diameter, and focus shape that are used. The technology table can distinguish between the required settings of the machine and the material-dependent parameters for laser welding. The NC program that controls the welding process on a laser welding system recites the number or the letter of the respectively required technology table. When performing the NC program, the technology tables are called by the numbers. Processing is then performed with the parameters of the table. All technology data can be centrally maintained. Intervention with the NC program is not necessary when individual parameters change. The parameters are changed in the technology table and are read during performing the NC program. The technology data can be changed and optimized without having any NC programming knowledge. Similar parts that are to be produced from different materials are programmed only once provided that the other materials can be processed with the same processing geometries. When the material changes, a new technology table is called. When activated in the NC program, a potentially diverging welding seam is factored in by the parameter entered into the new technology table.

The process gas may be mixed from five individual gases (He, Ar, CO₂, O₂, N₂) in dependence on the processing task (material type, joining geometry) and on the required process parameters (laser power, gating frequency, focal length or focus diameter, focus position, amount of process gas, gas mixing ratio and welding speed) to obtain optimum impact of the gas. The process parameters refer to a certain welding depth or seam shape.

To ensure optimum welding seam quality, the amount of process gas and the mixing ratio of the process gas are adjusted to the laser power or the welding speed. The user applies a welding technology table in the NC program, which corresponds to the processing task, required welding depth or seam shape. The controller 12 provides the gas mixing unit with the corresponding information of the table and the gas mixing unit makes then the gas mixture available to the laser processing system 1.

1. Laser processing system comprising
a laser processing device,
a gas mixing unit, and
an electronic process gas controller connected with the gas mixing unit for controlling and adjusting a composition of a process gas supplied to the laser processing device from the gas mixing unit,
wherein the electronic process gas controller includes a technology table data storage for storing technology tables configured to control and adjust the composition of the process gas during operation of the laser processing device.

2. The laser processing system of claim 1, wherein the electronic process gas controller is configured to automatically control and adjust the composition of the process gas.

3. The laser processing system of claim 1, wherein the electronic process gas controller is configured to control and adjust the composition of the process gas by NC programming.

4. The laser processing system of claim 1, wherein the electronic process gas controller includes an interactive user communication interface.

5. The laser processing system of claim 1, wherein the electronic process gas controller is configured to automatically control and adjust the composition of the process gas by NC programming.

6. The laser processing system of claim 1, wherein at least one of the technology tables includes data for a composition of the process gas that depend at least on one of laser power, feed rate, focus diameter, and focus shape to be applied during operation of the laser processing device.

7. The laser processing system of claim 1, wherein the technology tables include data indicative of required settings of the laser processing device.

8. The laser processing system of claim 1, wherein the technology tables include data indicative of material-dependent parameters of the laser processing device.

9. The laser processing system of claim 1, wherein the laser processing device is configured for laser welding.

10. The laser processing system of claim 1, further comprising a gas supply unit.

11. The laser processing system of claim 10, wherein the gas supply unit is configured to provide at least one of He—, Ar—, CO₂—, O₂—, and N₂ gas to the gas mixing unit.

12. A method for laser processing using a process gas, the method comprising:
providing a set of gas sources, the gas sources being connected to a gas mixing unit;
reading a technology table wherein data of the technology table are indicative of the contributions of each of the gases from the gas sources to the process gas;
based on the technology table, controlling the gas mixing unit to provide the process gas during laser processing; and
laser processing while the gas mixture being made available to the laser processing.

13. The method of claim 12, further comprising:
generating the technology table based on at least on one of laser power, feed rate, focus diameter, and focus shape to be applied during operation of the laser processing device.

14. The method of claim 12, further comprising:
selecting the technology table from a set of technology tables, each being associated with a different type of laser processing.

15. The method of claim 12, wherein the controlling is based on a NC program.
